(19) United States
(12) Patent Application Publication
(10) Pub. No.: US 2026/0048593 A1
(43) Pub. Date: Feb. 19, 2026

(54) CORONA TREATMENT APPARATUS

(71) Applicant: Canon Production Printing Holding B.V., Venlo (NL)

(72) Inventors: Sandor H.G. JOPPEN, Venlo (NL); Hermanus M. KUYPERS, Venlo (NL)

(73) Assignee: Canon Production Printing Holding B.V., Venlo (NL)

(21) Appl. No.: 19/295,872

(22) Filed: Aug. 11, 2025

(30) Foreign Application Priority Data
Aug. 14, 2024 (EP) 24194478.4

(51) Int. Cl. B41J 11/00; D03D 1/00; D03D 15/25

(52) U.S. Cl. CPC B41J 11/0015; D03D 1/00; D03D 15/25

(57) ABSTRACT

A corona treatment apparatus comprising a conveyor (10) for conveying sheets (18) to be treated along a transport path (16), a number of corona electrodes (20) disposed along the conveyor (10) on a first side of the transport path (16), a ground electrode (22) arranged on an opposite second side of the transport path (16) and opposite to the corona electrodes (20), and a suction box (26) for attracting the sheets (18) to the ground electrode (22) by drawing-in air through perforations of the ground electrode, wherein the ground electrode (22) is stationary and the conveyor (10) has a perforated conveyor belt (12) that runs over the ground electrode (22) and is made of a dielectric material, characterized in that the conveyor belt (12) has perforations that are larger than the perforations in the ground electrode (22).

### BACKGROUND OF THE INVENTION

### 1. Field of the Invention

The invention relates to a corona treatment apparatus comprising a conveyor for conveying sheets to be treated along a transport path, a number of corona electrodes disposed along the conveyor on a first side of the transport path, a ground electrode arranged on an opposite second side of the transport path and opposite to the corona electrodes, and a suction box for attracting the sheets to the ground electrode by drawing-in air through perforations of the ground electrode, wherein the ground electrode is stationary and the conveyor has a perforated conveyor belt that runs over the ground electrode and is made of a dielectric material.

Such treatment apparatus is used in the printing industry for subjecting media sheets to a corona treatment before printing in order to modify the surface energy of the sheets and thereby to improve the wettability of the sheets with ink.

### 2. Description of the Related Art

WO 2017 198390 A1 describes a corona treatment apparatus, wherein the conveyor is a belt conveyor having an electrically conductive conveyor belt which also serves as the ground electrode. The conveyor belt has perforations so that air may be sucked into the suction box through the perforations of the belt so as to attract the sheets to the surface of the belt while they are transported past the corona electrodes. A problem is that the perforations in the belt serving as ground electrode may lead to inhomogeneities in the corona discharge pattern which result in visible artifacts in the printed image.

A treatment apparatus according to the preamble of claim 1 has been disclosed in WO 2018/088381 A1.

Since, in this apparatus, the ground electrode does not have to serve as a conveyor belt, it does not have to be flexible. This gives more freedom of choice in the design and material of the counter electrode. In particular, the perforations can be so small and so finely distributed that the discharge pattern becomes more homogeneous, and this homogeneity is further enhanced by the fact that the perforations of the ground electrode are covered by the dielectric material of the conveyor belt which serves as a dielectric discharge barrier that smoothens irregularities in the corona discharge pattern. Next to this, also the locations of the perforations in the ground electrode are not fixedly positioned relative to the media position, such that the perforations in the ground electrode do not move along with the media positioned on top of the conveyor belt.

### SUMMARY OF THE INVENTION

It is the object of the invention to provide an improved treatment apparatus.

In order to achieve this object, the apparatus according to the invention is characterized in that the conveyor belt has perforations that are larger than the perforations in the ground electrode.

It has been found that the impact of the perforations in the conveyor belt on the corona discharge pattern is so small that It does not lead to visible artifacts in the printed image.

More specific optional features of the invention are indicated in the dependent claims

The ground electrode or at least a surface layer thereof may be made of a porous material or a woven cloth of metal wires which should preferably have a thickness of 1 mm or less, more preferably 0.2 mm or less and more preferably several tens of nm or less. Consequently, the mesh size or pore size of the fabric will be in the same order of magnitude as the wire thickness, which is preferably 0.33 mm or less, which results in a smooth and highly meshed electrode surface.

The perforations in the dielectric conveyor belt may be significantly larger than the mesh of the ground electrode, and the thickness of the conveyor belt may be of the same order of magnitude as the thickness of the sheets to be treated, so that the barrier effect is comparable to the barrier effect caused by the sheets themselves.

### BRIEF DESCRIPTION OF THE DRAWINGS

An embodiment example will now be described in conjunction with the drawings, wherein:

FIG. 1 is a schematic view of a corona treatment apparatus according to the invention.

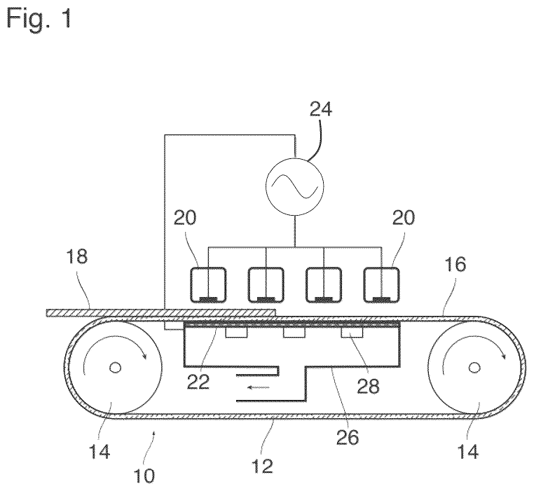

### DETAILED DESCRIPTION OF EMBODIMENTS

The corona treatment apparatus shown in the single drawing comprises a conveyor 10 having an endless belt 12 trained over two rollers 14. The upper run of the conveyor belt 12 defines a sheet transport path 16 for media sheets 18 to be subjected to a corona treatment.

As is well known in the art, a number of corona electrodes 20 are arranged along and above the sheet transport path 16 while a ground electrode 22 is arranged below the sheet transport path so as to oppose the corona electrodes 20. The corona electrodes 20 and the ground electrode 22 are connected to a voltage source 24 (AC). The output voltage of the voltage source 24 is so high that corona discharges occur between each corona electrode 20 and the ground electrode 22 and, when a sheet 18 is present, the discharge current effects a surface treatment of the top surface of the sheet.

In the apparatus according to the invention the dielectric comprises the upper run of the conveyor belt 12 which is made of a dielectric, i.e. electrically non-conductive, material and has a thickness that is in the order of magnitude of the thickness of the sheets 18.

The conveyor belt 12 has perforations formed therein, and the ground electrode 22 is made of a porous material and forms the top surface of a suction box 26 that is connected to a vacuum source, so that air is drawn in through the perforations of the conveyor belt 12 and the perforations of the ground electrode 22 which, in the example shown, is stabilized by support structures 28 in the suction box. Since the suction box 26 attracts the sheets 18 to the surface of the conveyor belt 12, it is possible to assure a constant spacing between the corona electrodes 20 and the surface of the sheets 18, which is critical for the efficiency of the corona treatment.

The ground electrode 22 may for example be formed by a woven fabric of metal wires having a thickness of less than 0.33 mm. In one embodiment, the thickness may be as small as 20 μm. As a result, the top surface of the ground electrode 22 is extremely smooth (with a roughness of not more than 10 μm), and its perforations have a very small mesh size and are finely distributed. These features contribute to the effect that the discharge pattern of the corona discharges is practically not distorted by any irregularities in the electrode surface, so that a very homogenous corona discharge is obtained and, as a consequence, the surface of the treated sheets 18 will have a uniform surface tension.

The perforations in the conveyor belt 12 may be significantly larger than the mesh size of the ground electrode 22 and may for example be formed by punching holes into the dielectric belt material. When a sheet 18 is being treated, the dielectric material of the sheet 18 that covers the holes of the conveyor belt acts as a discharge barrier to the corona discharges similarly as the dielectric material of the conveyor belt when no pores are present. Under these circumstances, the impact of the holes in the conveyor belt on the corona discharge patterns is negligible.

1. A corona treatment apparatus comprising a conveyor (10) for conveying sheets (18) to be treated along a transport path (16), a number of corona electrodes (20) disposed along the conveyor (10) on a first side of the transport path (16), a ground electrode (22) arranged on an opposite second side of the transport path (16) and opposite to the corona electrodes (20), and a suction box (26) for attracting the sheets (18) to the ground electrode (22) by drawing-in air through perforations of the ground electrode, wherein the ground electrode (22) is stationary and the conveyor (10) has a perforated conveyor belt (12) that runs over the ground electrode (22) and is made of a dielectric material, characterized in that the conveyor belt (12) has perforations that are larger than the perforations in the ground electrode (22).

2. The apparatus according to claim 1, wherein the perforations in the ground electrode (22) have a size of not more than 0.2 mm, preferably not more than 20 μm.

3. The apparatus according to claim 1, wherein the ground electrode is made of an electrically conductive fabric.

4. The apparatus according to claim 3, wherein the fabric of the ground electrode (22) is a woven fabric of metal wires having a thickness of not more than 1 mm, preferably not more than 0.2 mm.

5. The apparatus according to claim 2, wherein the ground electrode is made of an electrically conductive fabric.

6. The apparatus according to claim 5, wherein the fabric of the ground electrode (22) is a woven fabric of metal wires having a thickness of not more than 1 mm, preferably not more than 0.2 mm.
